(19) United States
(12) Patent Application Publication
(10) Pub. No.: US 2017/0031724 A1
(43) Pub. Date: Feb. 2, 2017

(54) APPARATUS, METHOD, AND COMPUTER PROGRAM FOR UTILIZING SECONDARY THREADS TO ASSIST PRIMARY THREADS IN PERFORMING APPLICATION TASKS

(71) Applicant: Futurewei Technologies, Inc., Plano, TX (US)

(72) Inventors: Jiachen Xue, West Lafayette, IN (US); Chen Tian, Union City, CA (US); Feng Ye, Mississauga (CA); Zongfang Lin, Santa Clara, CA (US)

(21) Appl. No.: 14/815,875

(22) Filed: Jul. 31, 2015

(51) Int. Cl. G06F 9/50

(52) U.S. Cl. CPC G06F 9/5061

(57) ABSTRACT

An apparatus, method, and computer program product are provided for utilizing secondary threads to assist primary threads in performing application tasks. In use, a plurality of primary threads are utilized for performing at least one of a plurality of tasks of an application utilizing at least one corresponding core. Further, it is determined whether the primary threads require assistance in performing one or more of the plurality of tasks of the application. Based on such determination, a plurality of secondary threads are utilized for performing the one or more of the plurality of tasks of the application.

### FIELD OF THE INVENTION

The present invention relates to parallel processing, and more particularly to utilizing threads in parallel for task completion.

### BACKGROUND

An increasing number of cores can be found on a single processor [e.g. central processing unit (CPU), etc.] of a device. However, it is uncommon for a single application to utilize all available cores all the time, during execution. As a result, multiple applications are typically scheduled to run concurrently on the same device to achieve both better resource utilization and higher throughput. Unfortunately, such resource sharing can potentially lead to conflicts which can, in turn, result in performance loss.

To avoid degrading performance due to resource contention, conventional resource managers and job schedulers are designed to provide resource separation. A typical technique involves assigning different sets of resources (e.g. cores, etc.) to different individual applications, and resource contention is avoided by restricting such applications to use only the assigned set of resources. Prior Art FIG. 1 illustrates a technique 100 for resource allocation among applications, in accordance with the prior art. As shown, a device 102 allocates a static number of cores to both a first application 104 and a second application 106.

Such prior art technique 100, which statically partitions cores among applications, has the potential of leading to poor resource utilization when dealing with applications that have dynamically changing workloads. In such situations, the set of cores assigned to one application may be underutilized while a different application may benefit from having more cores assigned to it. For example, as shown in Prior Art FIG. 1, the cores 108 of the first application 104 are shown to be utilized, while at least a portion of the cores 110 of the second application 106 are shown to be unutilized. Due to such static partitioning, the application (e.g. the first application 104, etc.) with a heavy workload is not able to migrate part of its work to cores of another application (e.g. the second application 106, etc.) that are underutilized.

There is thus a need for addressing these and/or other issues associated with the prior art.

### SUMMARY

An apparatus, method, and computer program product are provided for utilizing secondary threads to assist primary threads in performing application tasks. In use, a plurality of primary threads are utilized for performing at least one of a plurality of tasks of an application utilizing at least one corresponding core. Further, it is determined whether the primary threads require assistance in performing one or more of the plurality of tasks of the application. Based on such determination, a plurality of secondary threads are utilized for performing the one or more of the plurality of tasks of the application.

### BRIEF DESCRIPTION OF THE DRAWINGS

Prior Art FIG. 1 illustrates a technique for resource allocation among applications, in accordance with the prior art.

FIG. 2 illustrates a method for utilizing secondary threads to assist primary threads in performing application tasks, in accordance with one embodiment.

FIG. 3 illustrates a system for utilizing secondary threads to assist primary threads in performing application tasks, in accordance with one embodiment.

FIG. 4 illustrates a method for utilizing secondary threads to assist primary threads in performing application tasks, in accordance with one embodiment.

FIG. 5 illustrates a technique for work sharing, in accordance with one embodiment.

FIG. 6 illustrates a technique for work stealing, in accordance with one embodiment.

FIG. 7 illustrates an exemplary data structure for facilitating the detection of a busy state in the context of a work sharing technique, in accordance with one embodiment.

FIG. 8 illustrates a method for work sharing and setting a busy state, in accordance with one embodiment.

FIG. 9 illustrates a method for work stealing, in accordance with one embodiment.

FIG. 10 illustrates a method for work stealing and setting a busy state, in accordance with one embodiment.

FIG. 11 illustrates the manner in which one or more methods disclosed herein may provide resource allocation, in accordance with one embodiment.

FIG. 12 illustrates a network architecture, in accordance with one possible embodiment.

FIG. 13 illustrates an exemplary system, in accordance with one embodiment.

### DETAILED DESCRIPTION

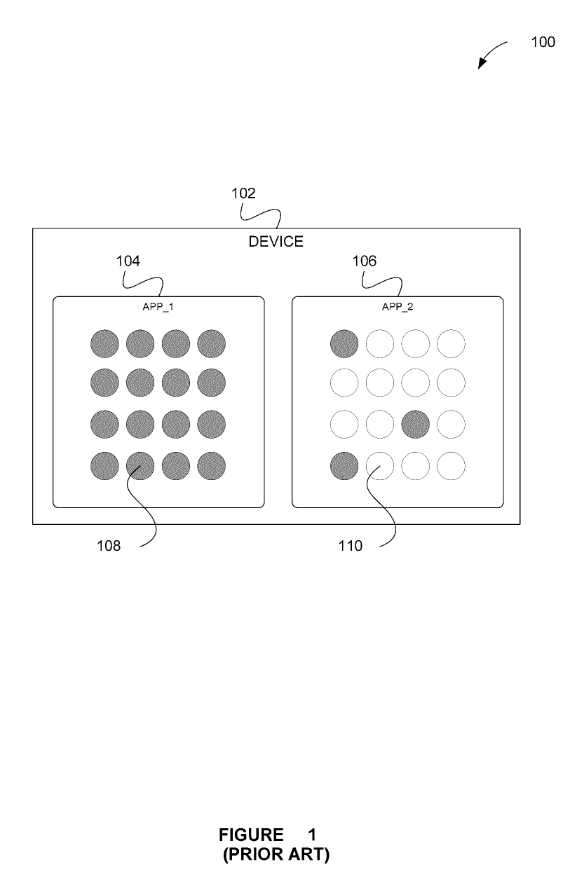

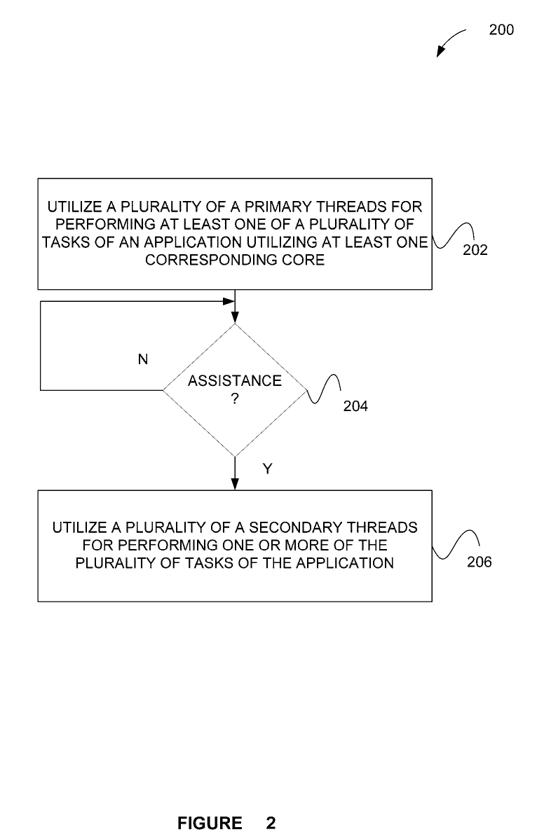

FIG. 2 illustrates a method 200 for utilizing secondary threads to assist primary threads in performing application tasks, in accordance with one embodiment. As shown, a plurality of primary threads are utilized for performing at least one of a plurality of tasks of an application utilizing at least one corresponding core. See operation 202.

In the context of the present description, a thread refers to any processing resource including, but not limited to processor execution time, processor execution bandwidth, a data structure for tracking task performance, a set sequence of instructions capable of task performance, and/or any other resource capable of being utilized to perform one or more tasks. Further, a task refers to any operation of the application, while a core refers to any portion of hardware (e.g. processor, etc.), software, and/or any other type of logic (e.g. physical and/or logical, etc.) capable of task performance. Still yet, in the present description, an application refers to any software program, computer code, and/or portion thereof.

As shown, in decision 204, it is determined whether the primary threads require assistance in performing one or more of the tasks of the application. If not, the primary threads continue to be utilized for application task performance, in the manner shown. In various embodiments, the determination of decision 204 may be carried out as a function of any aspect of the manner in which the primary threads are utilized in operation 202, where such aspect(s) are direct or indirect indicators of whether the primary threads require assistance. A variety of examples of such aspects will be set forth for illustrative purposes during the description of later embodiments.

If it is determined that the primary threads require assistance in performing the one or more tasks of the application, per decision 206, a plurality of secondary threads are utilized for performing the one or more tasks of the application. See operation 206. In the context of the present description, the secondary threads may include any threads that differ in at least one aspect (e.g. physical, logical, otherwise, etc.) with respect to the primary threads. For example, in one embodiment, such secondary threads may be spare threads separate from the primary threads.

It should be noted that a core utilized in connection with operation 206 may or may not be the same as the corresponding core utilized in connection with operation 202. Still yet, while a single decision 204 is illustrated in the context of the present embodiment, it should be noted that operation 206 may be conditionally performed as a function of multiple decisions, in other embodiments. Just by way of example, in another embodiment, it may be determined whether at least one other core is idle, and the secondary threads may be utilized for performing the one or more tasks of the application, if it is determined that the at least one other core is idle.

More illustrative information will now be set forth regarding various optional architectures and uses in which the foregoing method may or may not be implemented, per the desires of the user. It should be strongly noted that the following information is set forth for illustrative purposes and should not be construed as limiting in any manner. Any of the following features may be optionally incorporated with or without the exclusion of other features described.

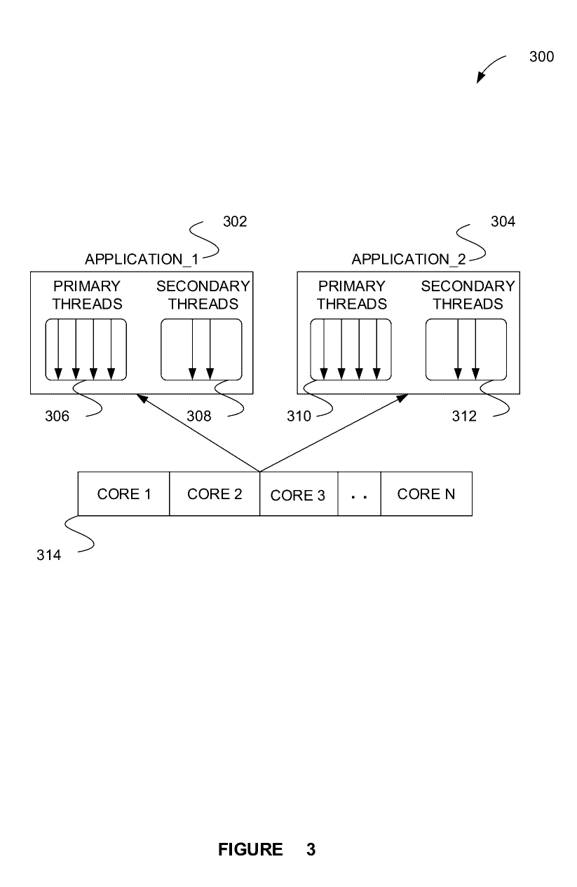

FIG. 3 illustrates a system 300 for utilizing secondary threads to assist primary threads in performing application tasks, in accordance with one embodiment. As an option, the system 300 may be implemented in the context of any one or more of the embodiments set forth in any previous and/or subsequent figure(s) and/or description thereof. Of course, however, the system 300 may be implemented in the context of any desired environment.

As shown, a plurality of applications are provided including a first application 302 and a second application 304. While such applications may take any form of software program or portion thereof, various examples of such applications may include office productivity applications (e.g. word processor, spreadsheet, presentation, etc. applications), entertainment applications (e.g. music player, video player, gaming, etc. applications), server applications (e.g. database server, web server, etc.), or any other types of applications, for that matter.

As further shown, each of the first application 302 and the second application 304 are each allocated primary threads 306, 310 (e.g. “worker” threads, etc.) and secondary threads 308, 312 (e.g. “helper” threads, etc.). In one embodiment, the primary threads 306, 310 and the secondary threads 308, 312 are each associated with different cores 314 which are utilized for executing the corresponding primary threads 306, 310 and secondary threads 308, 312 in completing the respective tasks of the first application 302 and the second application 304.

To this end, during runtime, two types of threads may be launched for each application: the primary threads 306, 310 and the secondary threads 308, 312. The number of primary threads 306, 310 may be specified by a programmer as a minimum requirement for launching the respective application 302, 304. To this end, in one embodiment, the primary threads 306, 310 may be of a predetermined number assigned to a particular corresponding application. Further, a number of secondary threads 308, 312 may be determined during runtime. In one exemplary, non-limiting embodiment, a sum of the number of the primary threads 306, 310 and secondary threads 308, 312 may be set to be equal to an amount of available cores 314 in a corresponding device.

During use, the primary threads 306, 310 may start work immediately after being created, while the secondary threads 308, 312 may be first put into a sleep mode and thereafter woken up (periodically or otherwise) to determine if it is time to start performing tasks. In one possible embodiment, such determination may be configured to satisfy two conditions: the corresponding core 314 is idle and the current amount of workload is more than the primary threads 306 or 310 can handle (they require assistance), in order for the secondary threads 308 or 312 to start work.

For example, in one embodiment, the primary threads 306 are implemented utilizing one of the corresponding cores 314 (CORE 1, for example), the primary threads 310 are implemented utilizing another one of the corresponding cores 314 (CORE 2, for example), and the secondary threads 308 and/or 312 are implemented utilizing yet another one of the corresponding cores 314 (CORE 3, for example), etc. In use, upon one or more of the secondary threads 308, 312 awakening, it may be first determined whether the corresponding core 314 (CORE 3) associated with the secondary threads 308 or 312 is busy. If not, the secondary threads 308 may be implemented utilizing CORE 3, thereby helping complete one or more tasks being performed by the primary threads 306. Thus, either or both of the secondary threads 308 or 312 may be implemented utilizing CORE 3. To this end, in one possible embodiment, multiple sets of secondary threads associated with different sets of primary threads may be equipped to utilize the same common core(s) (e.g. CORE 3, etc.).

In another embodiment, a thread (first thread) of the primary threads 306 is implemented utilizing one of the cores 314 (CORE 1, for example), a thread (second thread) of primary threads 310 is implemented utilizing another one of the cores 314 (CORE 2, for example), and a thread of the secondary threads 308 (third thread) and a thread of the secondary threads 312 (fourth thread) are implemented utilizing yet another one of the cores 314 (CORE 3, for example). Upon the third thread awakening, it may be determined whether CORE 3 is busy. If CORE 3 is not busy, or if CORE 3 is not busy and it is determined that CORE 1 is busy, the third thread may be implemented utilizing CORE 3, thereby completing one or more tasks being or to be performed by the first thread utilizing CORE 1. Upon the fourth thread awakening, it may also be determined whether CORE 3 is busy. If CORE 3 is not busy, or if CORE 3 not busy and it is determined that CORE 2 is busy, the fourth thread may be implemented utilizing CORE 3, thereby completing one or more tasks being or to be performed by the second thread utilizing CORE 2.

In other embodiments, the secondary threads 308, for example, may be implemented utilizing one or more core(s) other than CORE 3 (e.g. even CORE1/CORE2, etc.) to the extent that any tasks currently being handled by the primary threads 306, 310 using such other cores (e.g. CORE1/CORE2, etc.), have been completed. For example, many (and even possibly all) cores 314 may be allocated to the primary threads 306, 310. Further, the secondary threads 308, 312 may be implemented utilizing any of such cores 314 allocated to the primary threads 306, 310, after such cores 314 are no longer needed for such use by the primary threads 306, 310. To this end, the secondary threads 308, 312 may be assigned to any of the cores 314 other than those currently used to complete tasks by their corresponding primary threads 306, 314 (respectively), such that the secondary threads 308, 312 may even be assigned to any core 314 assigned to primary/secondary threads working on other tasks.

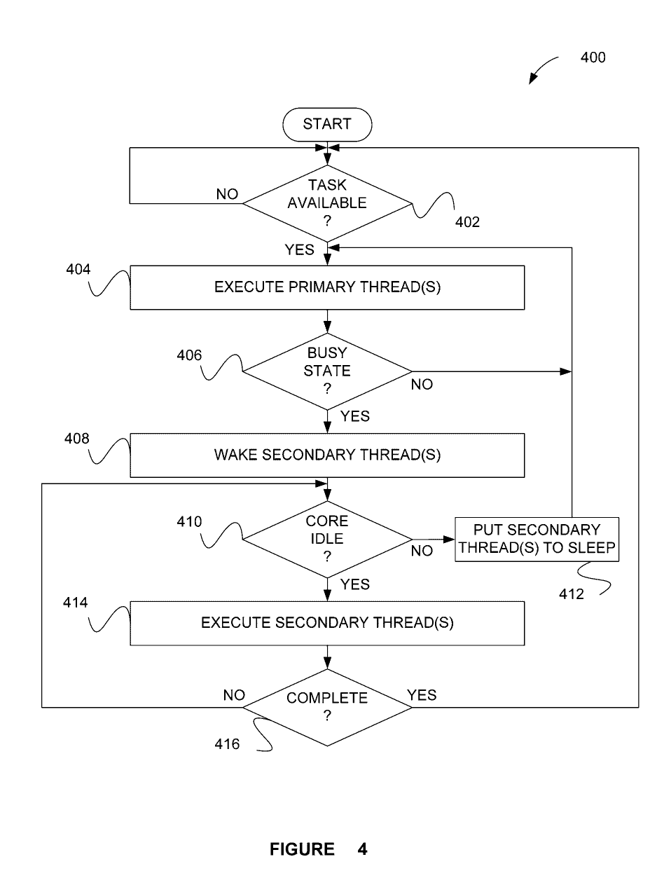

FIG. 4 illustrates a method 400 for utilizing secondary threads to assist primary threads in performing application tasks, in accordance with one embodiment. As an option, the method 400 may be implemented in the context of any one or more of the embodiments set forth in any previous and/or subsequent figure(s) and/or description thereof. Of course, however, the method 400 may be implemented in the context of any desired environment.

As shown, the method 400 begins with a determination whether a task is available and in need of processing to perform the same. See decision 402. If so, a primary thread(s) is executed for utilizing a corresponding core to perform the task, as indicated in operation 404.

During the execution of the primary thread(s), it is periodically or otherwise determined whether the primary thread(s) is experiencing a busy state. See decision 406. In the context of the present description, such busy state may refer to any state whereby the primary thread(s) requires assistance in performing one or more of a plurality of tasks of an associated application.

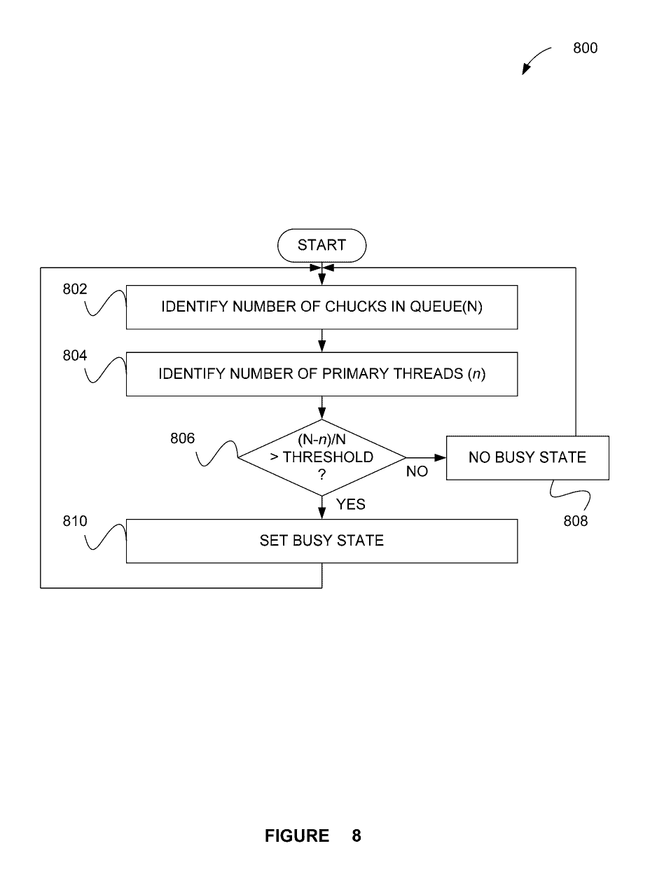

Of course, such requirement of assistance may be defined in any way and not necessarily be a function of whether the primary thread(s) is stalling, failing, etc. In other words, such requirement of assistance may be determined merely based on a workload or other aspect(s) of primary thread(s) execution, for preventative purposes, overall optimization, and/or any other purposes, for that matter. Various examples of the manner in which the busy state may be established will be set forth hereinafter in the context of different embodiment shown in subsequent figures. See FIGS. 8 and/or 10, for example.

If it is determined that the primary thread(s) is in a busy state per decision 406, the secondary thread(s) is awakened. See operation 408. Once wakened, the secondary thread(s) may be pinned to a separate core(s), and it is determined whether the core(s) associated with such secondary thread(s) is idle. See decision 410. In one embodiment involving a Linux system, an idle condition may be based on a utilization rate which may be read from “/proc/stat.”

If the core is not idle, the awakened secondary thread(s) is put back into a sleep state, and the primary thread(s) is relied upon to complete the associated application program task. See operation 412. In one embodiment, a possible purpose of such decision 410 is to ensure that resources (e.g. cores, etc.) that are already in use for one application are not “stolen” for another application, which would simply shift resource issues from one place to another. Of course, in other embodiments, a priority scheme or the like may be used to arbitrate such allocation among different applications, in lieu of or in addition to decision 410.

If it is determined that the core(s) associated with the secondary thread(s) is idle in decision 410, the secondary thread(s) may be executed in operation 414 to assist the primary thread(s) in task completion. To this end, the secondary thread(s) may continue execution until either the associated core(s) is no longer idle per decision 410 or the task(s) is completed per decision 416, in which case the method 400 is complete.

In various embodiments, the manner in which the secondary thread(s) is woke and executed may be in accordance with a work “sharing” or “stealing” framework, the details of which will be set forth hereinafter in greater detail. In any case, the secondary thread(s) may benefit its own associated application, and at the same time, not necessarily hurt the performance of other applications. As a result, the secondary thread(s) may stop working as soon as it detects the corresponding core getting busy again.

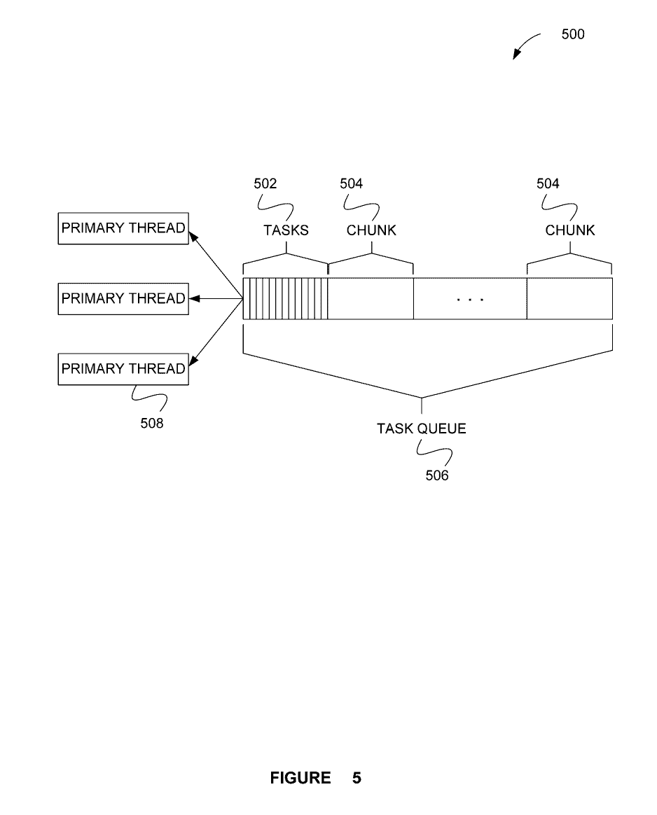

FIG. 5 illustrates a technique 500 for work sharing, in accordance with one embodiment. As an option, the technique 500 may be implemented in the context of any one or more of the embodiments set forth in any previous and/or subsequent figure(s) and/or description thereof. Of course, however, the technique 500 may be implemented in the context of any desired environment.

As shown, the work sharing technique 500 involves a plurality of tasks 502 in a central task queue 506. In use, the tasks 502, when created, are put into the central task queue 506 which is shared among a plurality of primary threads 508. Further, as shown, the tasks 502 in the central task queue 506 are divided into the chunks 504. To this end, each primary thread 508 may retrieve one of the chunks 504 every time it runs out of tasks 502 to complete.

More information regarding an exemplary method of carrying out the work sharing technique 500 and determining a busy state of the primary threads will be set forth during the description of FIG. 8. As will soon become apparent, in a work “sharing” embodiment, the secondary thread(s) checks a core utilization rate after it finishes a current chunk of tasks and before it asks a central task queue for more tasks. If the core utilization rate is above the threshold, the helper thread may be put back to the sleep state; otherwise, it may continue working. In implementation, core utilization statistics offered by the operating system may be obtained by sampling, and thus not in real-time. For the secondary thread to check core utilization rate after finishing the current chunk of tasks, it may first be put into a sleep state for a short period of time to avoid falling into the sampling period of the operating system. Thus, in various embodiments, dynamic thread launch and core reclaiming are afforded. Further, dynamic resource assignment may be implemented based on real-time workload information that benefits resource utilization and/or application throughput.

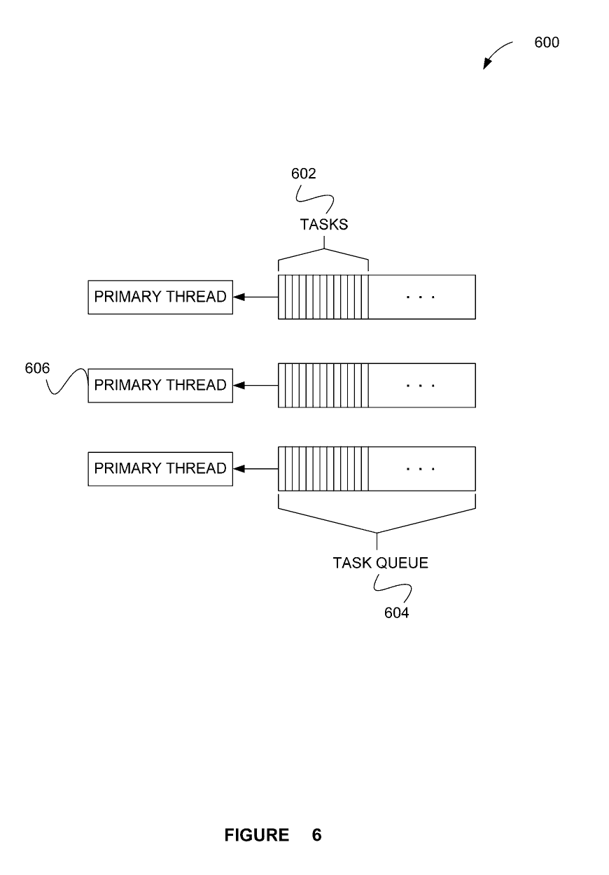

FIG. 6 illustrates a technique 600 for work stealing, in accordance with one embodiment. As an option, the technique 600 may be implemented in the context of any one or more of the embodiments set forth in any previous and/or subsequent figure(s) and/or description thereof. Of course, however, the technique 600 may be implemented in the context of any desired environment.

As shown, similar to the work sharing technique 500 of FIG. 5, the work stealing technique 600 involves a plurality of tasks 602 grouped in chunks (not shown). However, instead of a central task queue, the work stealing technique 600 utilizes a plurality of separate local queues 604 that are each assigned to a corresponding one of a plurality of primary threads 606.

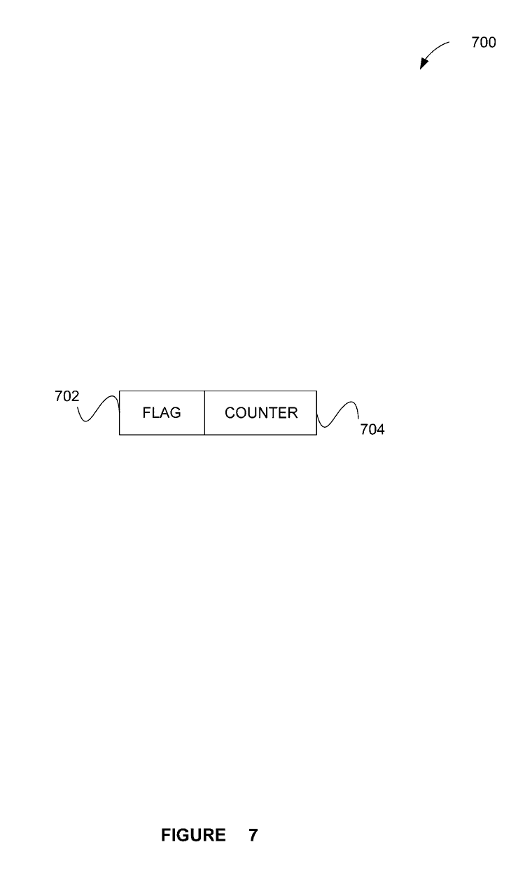

In use, when one of the primary threads 606 finishes all the tasks in the corresponding local queue 604, another primary thread 606 (and its local queue 604) is randomly (or otherwise) selected, and tasks are “stolen” from it. More information regarding an exemplary method of carrying out the work stealing technique 600 and determining a busy state of the primary threads will be set forth during the description of FIGS. 7, and 9-10. As will further soon become apparent, in a work “stealing” embodiment, the secondary thread(s) checks a core utilization rate after finishing a certain number of tasks (this number may or may not be preset). If the core is busy again, it may stop working and sends all its remaining tasks to a random target primary thread(s). Of course, any desired technique may be utilized.

To facilitate the detection of the busy state in the context of the work stealing technique 600, any desired data structure may be utilized. FIG. 7 illustrates an exemplary data structure 700 for facilitating the detection of a busy state in the context of a work stealing technique, in accordance with one embodiment. As will soon become apparent, to detect a busy state in the context of the work stealing technique 600, each primary thread maintains a flag 702, which indicates if the corresponding primary thread has been a stealing target before, and a counter 704, which keeps track of the portion of the associated local task queue 604 that has been finished.

In one embodiment, during use, the primary thread(s) may set/unset the flag 702 to indicate whether there is a large amount of tasks that cannot be handled by the current primary thread(s). Since the secondary thread(s) and primary thread(s) may share the same memory address, such flag 702 may be easily accessed by the secondary thread(s). The secondary thread(s) can also be periodically woken up to check whether a busy state exists and a current core utilization rate, in a manner that will soon become apparent.

FIG. 8 illustrates a method 800 for work sharing and setting a busy state, in accordance with one embodiment. As an option, the method 800 may be implemented in the context of any one or more of the embodiments set forth in any previous and/or subsequent figure(s) and/or description thereof. For example, the method 800 may be implemented in the context of the work sharing technique 500 of FIG. 5. Of course, however, the method 800 may be implemented in the context of any desired environment.

As shown, a number of chunks (e.g. chunks 504 of FIG. 5, etc.) may be identified in a central task queue (e.g. queue 506 of FIG. 5, etc.). See operation 802. Still yet, a number of primary threads (e.g. primary threads 508 of FIG. 5, etc.) may be identified. See operation 804.

To this end, the busy state may be determined based a threshold in relation to a value defined in Equation #1 below.

(N−n)/N, where Equation #1
N is a total number of tasks in a queue, and
n is a number of the primary threads.

Thus, if the aforementioned value is greater than a predetermined threshold per decision 806, the busy state may be set. See operation 810. As a result, the secondary threads may be utilized for performing one or more of the plurality of tasks of the application. On the other hand, if the aforementioned value is not greater than a predetermined threshold per decision 806, no busy state is set. See operation 808.

The threshold may therefore be set such that, if the current amount of workload is more than the primary threads can handle, secondary threads may start working if the corresponding core is currently idle.

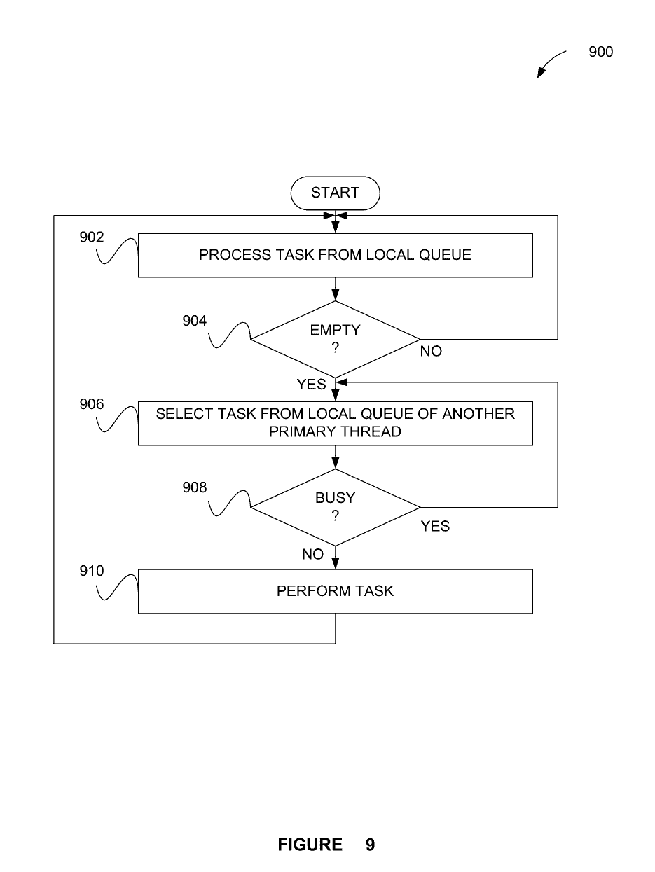

FIG. 9 illustrates a method 900 for work stealing, in accordance with one embodiment. As an option, the method 900 may be implemented in the context of any one or more of the embodiments set forth in any previous and/or subsequent figure(s) and/or description thereof. For example, the method 900 may be implemented in the context of the work stealing technique 600 of FIG. 6. Of course, however, the method 900 may be implemented in the context of any desired environment.

As shown, a task (e.g. task 602 of FIG. 6, etc.) is selected from a local queue (e.g. local queue 604 of FIG. 6, etc.) for processing. See operation 902. This is continued until the local queue is determined to be empty in decision 904.

Once the local queue is determined to be empty in decision 904, a task is selected from another local queue of another primary thread (e.g. primary thread 606 of FIG. 6, etc.). See operation 906. As mentioned earlier, such other local queue/primary thread may be selected randomly and/or by any other desired algorithm.

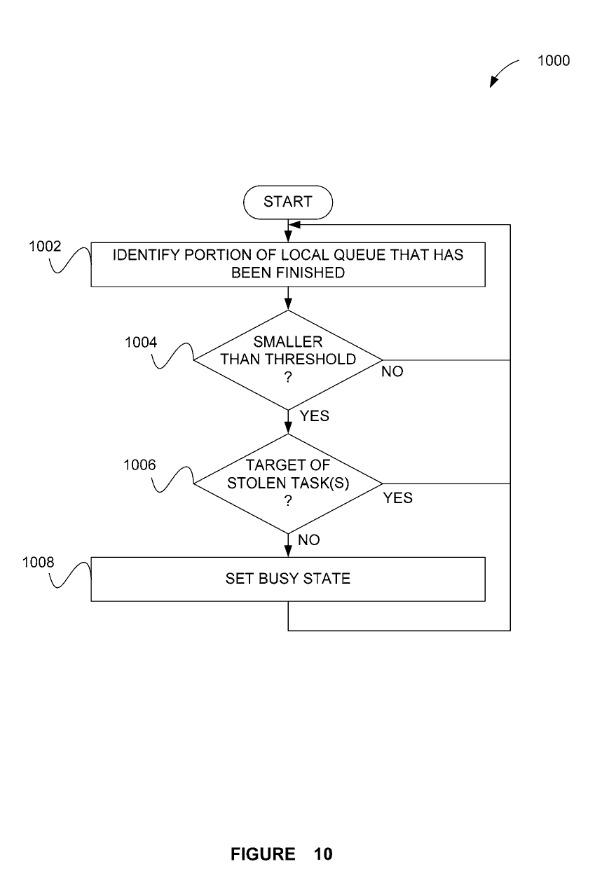

Once the other local queue/primary thread is selected, it is determined whether it is in a busy state. See decision 908. More information regarding an exemplary method of carrying out the work stealing method 900 and determining a busy state of the primary threads will be set forth during the description of FIG. 10. In one possible embodiment, once the other local queue/primary thread is selected, it may be determined whether such local queue is empty. If so, operation 906 is determined to be unsuccessful, and the selection process of operation 906 is repeated. This continues until the selected local queue is not empty, in which case the associated task may be performed. See operation 910. To this end, the method 900 selects another primary thread to seek for tasks available for processing, until either the stealing is successful or all primary threads run out of tasks.

FIG. 10 illustrates a method 1000 for work stealing and setting a busy state, in accordance with one embodiment. As an option, the method 1000 may be implemented in the context of any one or more of the embodiments set forth in any previous and/or subsequent figure(s) and/or description thereof. For example, the method 1000 may be implemented to determine a busy state in the context of the work stealing technique 600 of FIG. 6, and further in the context of the method 900 for work stealing of FIG. 9. Of course, however, the method 1000 may be implemented in the context of any desired environment.

As shown, a portion of tasks (e.g. task 602 of FIG. 6, etc.) in a queue (e.g. local queue 604 of FIG. 6, etc.) that has been finished, is identified. See operation 1002. It is then determined whether the portion of tasks in the queue that has been finished is less than a predetermined threshold. See decision 1004. It is also determined whether at least one of the primary threads (e.g. primary thread 606 of FIG. 6, etc.) has been subject of a task being taken therefrom (e.g. stolen, etc.). See decision 1006. As mentioned earlier during the description of FIG. 7, the determinations in decisions 1004 and 1006 may be performed based a data structure that stores information on the portion of tasks in the queue that has been finished, as well as information on whether at least one of the primary threads has been subject of the task being taken therefrom.

If both decisions 1004 and 1006 have been decided such that the threshold has not been exceeded and the primary thread has not been the subject of stealing, the busy state may be set. See operation 1008. To this end, the secondary threads may be utilized for performing one or more of the plurality of tasks of the application, in a situation where all cores assigned to a particular application are fully utilized and requires more cores.

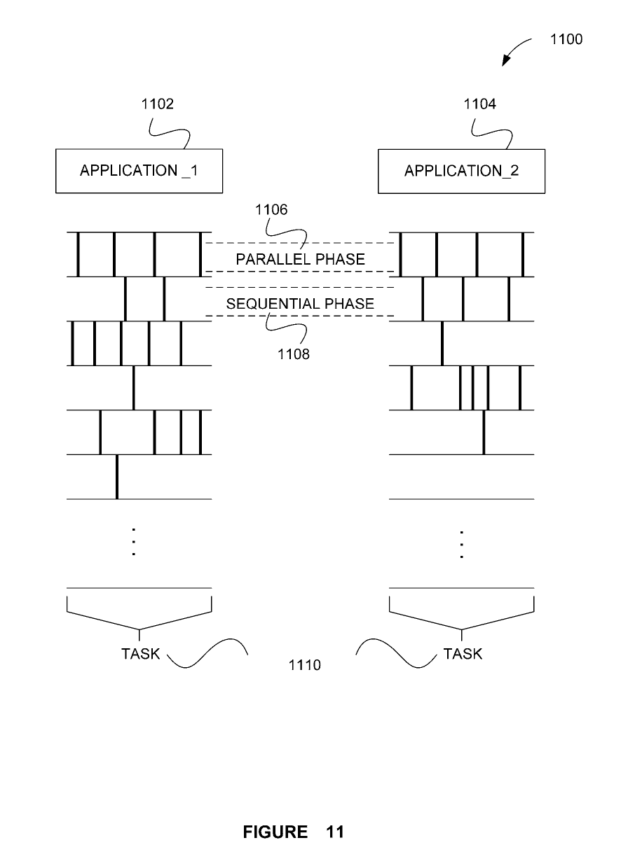

FIG. 11 illustrates the manner 1100 in which one or more methods disclosed herein may provide resource allocation, in accordance with one embodiment. As an option, the present technique may be exhibited in the context of any one or more of the embodiments set forth in any previous and/or subsequent figure(s) and/or description thereof. Of course, however, the present technique may or may not be exhibited in different embodiments.

As shown, two applications 1102, 1104 may have associated tasks 1110 that are performed, during use. At certain times, the tasks 1110 of the two applications 1102, 1104 may each require full utilization of threads (e.g. “parallel phase” 1106, etc.). At others times, one or more of the tasks 1110 of the two applications 1102, 1104 may not necessarily require full utilization of threads (e.g. “sequential phase” 1108, etc.). In the latter case, the resource allocation of one or more embodiments disclosed herein may afford better resource utilization and/or higher throughput, by virtue of the resources being dynamically allocated where needed.

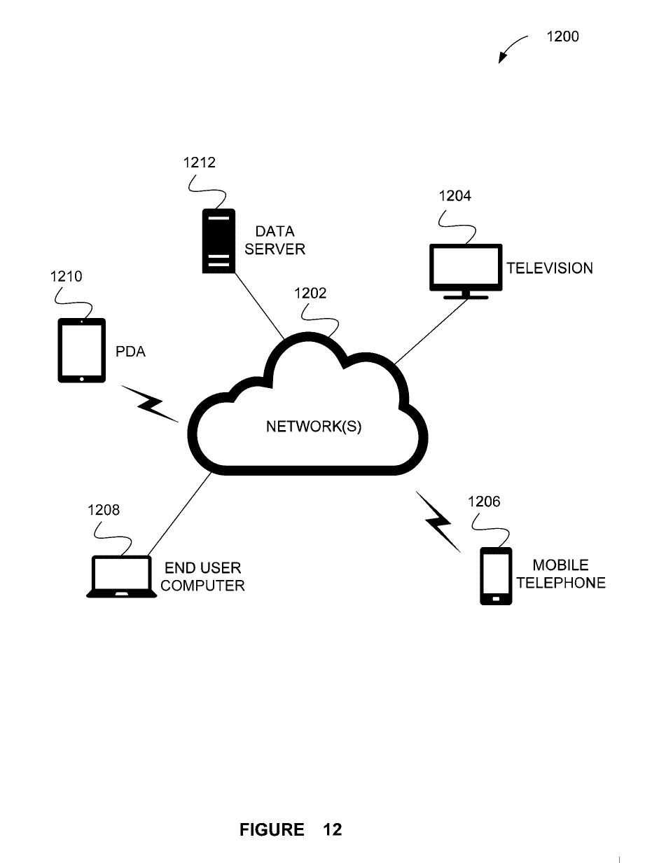

FIG. 12 illustrates a network architecture 1200, in accordance with one possible embodiment. As an option, the present network architecture 1200 may be implemented in the context of any one or more of the embodiments set forth in any previous and/or subsequent figure(s) and/or description thereof. For example, any one or more of the various devices shown in FIG. 12 may incorporate the methods and techniques described in earlier embodiments.

As shown, at least one network 1202 is provided. In the context of the present network architecture 1200, the network 1202 may take any form including, but not limited to a telecommunications network, a local area network (LAN), a wireless network, a wide area network (WAN) such as the Internet, peer-to-peer network, cable network, etc. While only one network is shown, it should be understood that two or more similar or different networks 1202 may be provided.

Coupled to the network 1202 is a plurality of devices. For example, a server computer 1204 and an end user computer 1206 may be coupled to the network 1202 for communication purposes. Such end user computer 1206 may include a desktop computer, lap-top computer, and/or any other type of logic. Still yet, various other devices may be coupled to the network 1202 including a personal digital assistant (PDA) device 1208, a mobile phone device 1210, a television 1212, etc.

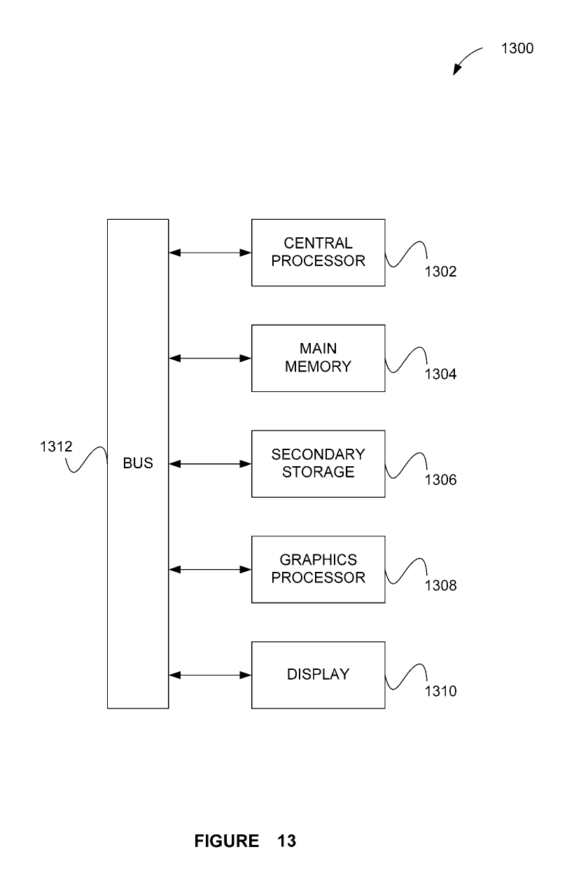

FIG. 13 illustrates an exemplary system 1300, in accordance with one embodiment. As an option, the system 1300 may be implemented in the context of any of the devices of the network architecture 1200 of FIG. 12. Of course, the system 1300 may be implemented in any desired environment.

As shown, a system 1300 is provided including at least one central processor 1301 which is connected to a communication bus 1302. The system 1300 also includes main memory 1304 [e.g. random access memory (RAM), etc.]. The system 1300 also includes a graphics processor 1306 and a display 1308.

The system 1300 may also include a secondary storage 1310. The secondary storage 1310 includes, for example, a hard disk drive and/or a removable storage drive, representing a floppy disk drive, a magnetic tape drive, a compact disk drive, etc. The removable storage drive reads from and/or writes to a removable storage unit in a well known manner.

Computer programs, or computer control logic algorithms, may be stored in the main memory 1204, the secondary storage 1210, and/or any other memory, for that matter. Such computer programs, when executed, enable the system 1200 to perform various functions (as set forth above, for example). Memory 1204, storage 1210 and/or any other storage are possible examples of non-transitory computer-readable media.

It is noted that the techniques described herein, in an aspect, are embodied in executable instructions stored in a computer readable medium for use by or in connection with an instruction execution machine, apparatus, or device, such as a computer-based or processor-containing machine, apparatus, or device. It will be appreciated by those skilled in the art that for some embodiments, other types of computer readable media are included which may store data that is accessible by a computer, such as magnetic cassettes, flash memory cards, digital video disks, Bernoulli cartridges, random access memory (RAM), read-only memory (ROM), and the like.

As used here, a “computer-readable medium” includes one or more of any suitable media for storing the executable instructions of a computer program such that the instruction execution machine, system, apparatus, or device may read (or fetch) the instructions from the computer readable medium and execute the instructions for carrying out the described methods. Suitable storage formats include one or more of an electronic, magnetic, optical, and electromagnetic format. A non-exhaustive list of conventional exemplary computer readable medium includes: a portable computer diskette; a RAM; a ROM; an erasable programmable read only memory (EPROM or flash memory); optical storage devices, including a portable compact disc (CD), a portable digital video disc (DVD), a high definition DVD (HD-DVD™), a BLU-RAY disc; and the like.

It should be understood that the arrangement of components illustrated in the Figures described are exemplary and that other arrangements are possible. It should also be understood that the various system components (and means) defined by the claims, described below, and illustrated in the various block diagrams represent logical components in some systems configured according to the subject matter disclosed herein.

For example, one or more of these system components (and means) may be realized, in whole or in part, by at least some of the components illustrated in the arrangements illustrated in the described Figures. In addition, while at least one of these components are implemented at least partially as an electronic hardware component, and therefore constitutes a machine, the other components may be implemented in software that when included in an execution environment constitutes a machine, hardware, or a combination of software and hardware.

More particularly, at least one component defined by the claims is implemented at least partially as an electronic hardware component, such as an instruction execution machine (e.g., a processor-based or processor-containing machine) and/or as specialized circuits or circuitry (e.g., discreet logic gates interconnected to perform a specialized function). Other components may be implemented in software, hardware, or a combination of software and hardware. Moreover, some or all of these other components may be combined, some may be omitted altogether, and additional components may be added while still achieving the functionality described herein. Thus, the subject matter described herein may be embodied in many different variations, and all such variations are contemplated to be within the scope of what is claimed.

In the description above, the subject matter is described with reference to acts and symbolic representations of operations that are performed by one or more devices, unless indicated otherwise. As such, it will be understood that such acts and operations, which are at times referred to as being computer-executed, include the manipulation by the processor of data in a structured form. This manipulation transforms the data or maintains it at locations in the memory system of the computer, which reconfigures or otherwise alters the operation of the device in a manner well understood by those skilled in the art. The data is maintained at physical locations of the memory as data structures that have particular properties defined by the format of the data. However, while the subject matter is being described in the foregoing context, it is not meant to be limiting as those of skill in the art will appreciate that various of the acts and operations described hereinafter may also be implemented in hardware.

To facilitate an understanding of the subject matter described herein, many aspects are described in terms of sequences of actions. At least one of these aspects defined by the claims is performed by an electronic hardware component. For example, it will be recognized that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

The embodiments described herein included the one or more modes known to the inventor for carrying out the claimed subject matter. Of course, variations of those embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

What is claimed is:

1. An apparatus, comprising:
at least one processor configured to utilize a plurality of primary threads for performing at least one of a plurality of tasks of an application utilizing at least one corresponding core, and further to utilize a plurality of secondary threads for performing one or more of the plurality of tasks of the application based on a determination whether the primary threads require assistance in performing the one or more of the plurality of tasks of the application.

2. The apparatus of claim 1, wherein the apparatus is operable such that the primary threads are of a predetermined number assigned to the application.

3. The apparatus of claim 1, wherein the apparatus is operable such that the secondary threads include a plurality of other primary threads for performing at least one of a plurality of other tasks of another application.

4. The apparatus of claim 1, wherein the apparatus is operable such that the secondary threads utilize at least one other core.

5. The apparatus of claim 4, wherein the apparatus is operable such that it is determined whether the at least one other core is idle.

6. The apparatus of claim 5, wherein the apparatus is operable such that the secondary threads are utilized for performing the one or more of the plurality of tasks of the application, based on the determination whether the at least one other core is idle.

7. The apparatus of claim 1, wherein the apparatus is operable such that the determination is performed as a function of a number of tasks in a queue.

8. The apparatus of claim 1, wherein the apparatus is operable such that the determination is performed as a function of a number of the primary threads.

9. The apparatus of claim 1, wherein the apparatus is operable such that the determination is performed as a function of the equation (N-n)/N, where N is a total number of tasks in a queue, and n is a number of the primary threads.

10. The apparatus of claim 1, wherein the apparatus is operable such that the determination is performed based on a portion of tasks in a queue that has been finished.

11. The apparatus of claim 1, wherein the apparatus is operable such that the secondary threads are utilized for performing the one or more of the plurality of tasks of the application, if a portion of tasks in a queue that has been finished is less than a predetermined threshold.

12. The apparatus of claim 11, wherein the apparatus is operable such that the determination is performed based a data structure that stores information on the portion of tasks in the queue that has been finished.

13. The apparatus of claim 1, wherein the apparatus is operable such that it is determined whether at least one of the primary threads has been subject of a task being taken therefrom.

14. The apparatus of claim 13, wherein the apparatus is operable such that the secondary threads are utilized for performing the one or more of the plurality of tasks of the application, based on the determination whether the at least one primary thread has been subject of the task being taken therefrom.

15. The apparatus of claim 14, wherein the apparatus is operable such that the determination whether the at least one primary thread has been subject of the task being taken therefrom is performed based a data structure that stores information on whether the at least one primary thread has been subject of the task being taken therefrom.

16. The apparatus of claim 1, wherein the apparatus is operable such that multiple sets of secondary threads associated with different sets of primary threads utilize at least one other common core.

17. A computer program product embodied on a non-transitory computer readable medium, comprising:
code for utilizing a plurality of primary threads for performing at least one of a plurality of tasks of an application utilizing at least one corresponding core;
code for determining whether the primary threads require assistance in performing one or more of the plurality of tasks of the application; and
code for utilizing a plurality of secondary threads for performing the one or more of the plurality of tasks of the application, based on the determination whether the primary threads require assistance in performing the one or more of the plurality of tasks of the application.

18. The computer program product of claim 17, wherein the computer program product is configured such that multiple sets of secondary threads associated with different sets of primary threads utilize at least one other common core.

19. A method, comprising:
utilizing a plurality of primary threads for performing at least one of a plurality of tasks of an application utilizing at least one corresponding core;
determining whether the primary threads require assistance in performing one or more of the plurality of tasks of the application; and
utilizing a plurality of secondary threads for performing the one or more of the plurality of tasks of the application, based on the determination whether the primary threads require assistance in performing the one or more of the plurality of tasks of the application.

20. The method of claim 19, wherein multiple sets of secondary threads associated with different sets of primary threads utilize at least one other common core.
